(19) United States
(12) Patent Application Publication
(10) Pub. No.: US 2006/0168881 A1
(43) Pub. Date: Aug. 3, 2006

(54) Hydroponic plant nutrient kit and method of use

(76) Inventor: Michael James Straumietis, Indio, CA (US)

Correspondence Address: Michael James Straumietis;Advanced Nutrients Ltd., #109 - 31063 Wheel Avenue, Abbotsford, BC, V2T 6H1, CA

(21) Appl. No.: 10/548,490

(22) PCT Filed: Apr. 4, 2003
(86) PCT No.: PCT/CA03/00504

§ 371 Date: Sep. 9, 2005

(30) Foreign Application Priority Data
Mar. 11, 2003 (CA) 2,421,961

(51) Int. Cl. A01G 31/00

(52) U.S. Cl. 47/62 R

(57) ABSTRACT

The present invention provides a complete, safe, cost-effective, simple-to-use, and pH balanced hydroponics nutrient feeding kit for culturing plants indoors, outdoors and in green houses, wherein the hydroponics nutrient feeding kit comprises a set of formulations for making chronologically sequential nutrient solutions to culture a hydroponic crop through an entire growth cycle, wherein each formulation comprises all of the nutrient components required in a batch of nutrient solution. The nutrient components are pre-measured for a specific hydroponic nutrient reservoir size to consistently provide plants with their nutrient requirements for the specific stage of growth through the vegetative phase and the flowering and fruiting phase through to harvest. The hydroponics nutrient feeding system can be used with rock-wool, sphagnum moss, leca, coir, lava rock, soil mixes, aeroponics, drip irrigation, flood and drain, wick, NFT, systems and all other hydroponic growth mediums and systems.

### FIELD OF THE INVENTION

The present invention pertains to the field of plant nutrients, in particular to a hydroponic nutrients kit and method of use.

### BACKGROUND TO THE INVENTION

Hydroponics for the home gardener started 25 years ago. Over the years, the use of hydroponics has grown in popularity, as has the availability of different hydroponic nutrients and supplements in the market place. However, with the hundreds of products in the marketplace, it is becoming more difficult for hydroponic gardeners to make and apply the right combination of nutrients and supplements, let alone to get optimal plan growth and harvests. Most home gardeners are not hydroponics experts, and do not possess the skills to fully realise the potential of their harvest. However, they do want to grow many varieties of flowers, herbs and vegetables as easily as possible.

The provision for the hydroponic gardener of a complete hydroponic nutrient system that delivers consistent and optimum yields is difficult at best, because almost all hydroponic fertilizers are extremely elementary and comprise only the few elements listed on the label. They do not contribute any of the additional elements, compounds or microbial structure that are necessary for healthy and optimum plant growth in a hydroponic garden.

Hydroponic plant nutrients manufactured for the home gardener and small scale commercial grower are sold separately, or as very basic 2-part or 3-part liquid or dry powder formulations comprising only macronutrients and micronutrients. In preparing a hydroponic nutrient solution, the quantity of each part needs to be properly calculated, and then carefully measured for the given reservoir size. The nutrients are then mixed together with water in the nutrient reservoir. The nutrient strength needs to be checked and adjusted to the proper concentration, typically expressed parts per million (ppm). Then the pH is painstakingly checked and to the optimal pH before the nutrient solution can be fed to the plants.

About 60 atomic elements have been found plans. It is believed that only 16 of these elements are needed for plants to sustain life, namely carbon, oxygen, and hydrogen from air and water, and 13 other elements classified as either macronutrients (nitrogen, phosphors, potassium, calcium, sulphur and magnesium, which the plant uses in larger amounts) or micronutrients (boron, chlorine, copper, manganese, molybdenum, and zinc, which plants use in small amounts). There is also a large variety of other compounds that stimulate and optimize plant growth: beneficial bacteria and fungi, enzymes yeast extracts, carbohydrates, amino acids, hormones, vitamins, organic ingredients and organic extracts.

However, it is not possible to put all these nutrients and supplements into the very basic 2-part and 3-part hydroponic formulations currently on the market without having their elements locking up or precipitating out of solution, and thus becoming unsuitable for absorption from the nutrient solution by the plant. Furthermore, combining certain compounds such as, for example beneficial bacteria and enzymes, would result in the premature and untimely activation of both the bacterial culture and the enzyme component of the nutrient formulation, as well as in the metabolism and depletion of the enzymes by the bacteria and/or rancidification of the enzymes.

The scope of introducing these additional nutrient components separately into hydroponic nutrient solution to take care of the entire plant is well beyond the skill of the typical hydroponic gardener, and therefore makes it even more difficult for the home hobbyist to get optimum vegetable, flower, and fruit yields.

Adding to the complexity, manufactures usually recommend adjusting the nutrient ratios as the plant matures and its nutritional requirements change. This process is repeated, usually on a weekly basis, making success for the home hydroponic gardener elusive. Additionally, there are numerous plant chemicals and supplements available to optimize plant growth and yield. In fact, there are so many different chemicals and supplements available, it often leaves the typical gardener unsure and very confused as to what product to select to optimize their garden. Buying the multitude of different nutrients and supplements available on the market to mix into a complete nutrient solution is impractical, inconvenient, time consuming, and complicated, requiring the time to study, learn and then correctly apply the acquired knowledge to grow fruits, vegetables and flowers. An additional burden on the hydroponic gardener is the time spent on periodic calibration of both pH and ppm electronic measuring devices, as well as the cost of purchasing these items and their calibration solutions.

This confusion results in some hydroponic gardeners using incomplete fertilizer combinations and wrong amounts of nutrients and supplements, and leads to the likelihood of inconsistent results from one batch of nutrient solution to another, and from one crop to another. Further, inappropriate mixing and misapplication of the plant nutrients results in poor plant growth or burning of roots and plant foliage, making for poor harvest.

Many plants have two distinct phases of development, a vegetative growth phase and a flowering and fruiting phase. A hydroponic gardener starts the vegetative growth phase by transplanting either a seedling or a rooted cutting into the desired growing medium. Depending on how big they want the plants to grow will determine how long they will keep the plants in the vegetative growth phase. This could be anywhere from a few days to 12 weeks.

A hydroponic gardener uses artificial light (usually high intensity discharge lighting such as metal halide or high-pressure sodium) to manipulate a plant's photoperiod and to obtain the deed results. During the vegetative growth phase, a lighting cycle of 18 hours or more in a 24 hour period is maintaining to hold the plants in their vegetative phase. When the plants have reached their desired size, the hydroponic gardener sets the lighting cycle to 12 hours in a 24 hour period to start the plants flowering and fang phase.

During these phases of vegetative growth, and flowering and fruiting, the nutrient reservoir is changed completely and refilled periodically as the plants use up the nutrients. This is done to insure that the plants have the proper amount of elements they need at all times.

The nutrient needs of the plants vary between the vegetative growing phase and the flowering and fruiting phase. Supplying the plants with the right nutrients in the proper ratios at the correct time for optimal plant growth in the vegetative growth phase and flowering and fruiting phase is the most difficult part for the hydroponic gardener.

Over the past 25 years, not one manufacturer of hydroponic plant nutrients has devised a complete, cost-effective, simple-to-use, and reproducible hydroponics nutrient feeding system for the home hydroponic gardener that lets ordinary people get extraordinary results.

A need, therefore, remains for an effective hydroponics nutrient feeding system for plants that is complete, cost-effective, simple-to-use, reproducible and chronologically sequential, taking into account the nutritional requirements for the particular stage of the plant's development.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the preset invention is to provide a hydroponic nut feeding system and method of uses thereof. The present invention provides a complete, cost-effective, simple-to-use, and reproducible, chronologically sequential, and pH balanced hydroponics nutrient feeding system for growing plants indoors, outdoors and in green houses, wherein the hydroponics nutrient feeding system comprises a master container which in turn comprises formulation containers, each of which contains packaged nutrient components, namely macro-nutrients, micro-nutrients, carbohydrates, amino acids, enzymes, vitamins, hormones, yeast exacts, beneficial bacteria, beneficial fungi, organic ingredients and organic extracts. All of the packaged nutrient components are pre-measured for a specific hydroponic nutrient reservoir size to provide plants with their nutrient requirements for the specific period of the plant's growth cycle through the vegetative phase and the flowering and fruiting phase through to harvest. The hydroponics nutrient feeding system is extremely simple, safe, consistent, easy to ship and cost-effective, and can be used with rock-wool, sphagnum moss, leca, coir, lava rock soil mixes, aeroponics, drip irrigation, flood and drain, wick, NFT systems and all other hydroponic growth mediums and systems.

Accordingly, the present invention overcomes all of the current obstacles to optimal hydroponic gardening by utilizing an integrated system. The primary advantages of the present invention is that it provides a complete, cost-effective, simple-to-use, and reproducible, chronologically sequential, and pH balanced plant nutrient feeding method and system comprising a complete and balanced plant feeding program for the whole plant, both above and below the soil, and that addresses the plant's changing nutritional needs as it matures.

According to this invention, a hydroponic gardener measures out the stated volume of water in the reservoir, empties the entire contents of all of the nutrient containers found in the form on container for the corresponding period of the plant's growth cycle. Then the hydroponic gardener thoroughly mixes the nutrient solution. The steps are repeated periodically, according to a schedule, throughout the growth cycle of the crop. The pH of the nutrient solution according to the method is self-adjusting to a pH range of 5.5 to pH 6.5, so that there is no need to check the pH during the preparation of the nutrient solution. Balancing and checking the pH, calibrating the ppm and pH electronic pens that most hydroponic gardener are all done away with.

There is no need for the hydroponic gardener to worry about determining proper combination of ingredients or calculating their proper amounts to measure and mix. The present invention incorporates a wide range of ingredients that helps hydroponic gardeners achieve extraordinary results that cannot be otherwise achieved with today's very basic 2-part and 3-part hydroponic formulations. All of the macronutrients, micronutrients, carbohydrates, amino acids, enzymes vitamins, hormones, yeast extracts beneficial bacteria, beneficial fungi organic ingredients and organic extracts have been precisely calculated, called, weighed and delivered in the precise ratios, and packaged in the chronologically-appropriate container for use at the exact time they are needed throughout a plant's entire growth cycle.

The determination of the appropriate nutrients and their appropriate quantities for the appropriate stage of plant development, and the pH balancing has been done for the hydroponic home gardener. All that is left to do is to measure out the correct volume of water according to the instructions.

In a further aspect, the present invention enables ordinary hydroponic home gardeners get extraordinary results, by employing nutrients for plant growth that are outside of the scope of knowledge of almost all home hydroponic gardeners and hydroponic nutrient manufacturers.

### BRIEF DESCRIPTION OF THE FIGURES

FIG. 1—Illustration of the master container.

FIG. 2—Top view illustration of master container.

FIG. 3—Illustration of formulation containers and nutrient containers.

Table 1—An exemplary schedule.

Table 2—List of beneficial fungi.

Table 3—List of beneficial bacteria.

Table 4—List of enzymes.

Table 5—List of amino acids.

Table 6—List of minerals and elements in mono- and ortho-silisic acid.

Table 7—List of components in Medicago sativa (alfalfa).

Table 8—List of components in Ascophyllum nodosum (kelp).

Table 9—Exemplary master container configurations.

### DETAILED DESCRIPTION OF THE INVENTION

The present invention provides a complete hydroponic nutrient system comprising all of the nutrients required for growing plants hydroponically, and method of uses thereof. The nutrients are provided in pre-measured units, packaged in a packaging system which allows the hydroponic gardener to mix the nutrients in an accurate and timely manner and thereby meet the nutritional requirements of the plant throughout its current stage of growth.

1. Definitions

Unless defined otherwise, all technical and scientific terms used herein have the same meaning as commonly understood by one of ordinary skill in the art to which this invention belongs.

The term “growth phase” as used herein refers to a phase of a plant's growth. The growth phases of a plant may include a germination phase if a plant is propagated from seed, a rooting phase if a plant is propagated from a cutting, a vegetative phase typically characterised by an increase in the biomass of a plant, a flowering and fruiting phase typically characterised by an increase in the number and biomass of blooms and/or fruiting bodies, and a senescence or finishing phase typically characterised by maturation of seeds and sometimes by loss of leaves or petals. The hydroponic gardener typically controls the growth phase of a plant by adjusting the nutrient content of a nutrient solution, the intensity and duration of a daily light cycle, ambient temperature, and other environmental parameter.

The term “growth cycle” as used herein refers to the length of time from the start of one growth phase to the end of that or a subsequent growth phase, as defined by a schedule. The growth cycle of a flowering plant such as an orchid may comprise the rooting phase, the vegetative phase and the flowering and fruiting phase where the desired crop comprises orchid flowers, or may comprise the rooting phase, the vegetative phase, the flowering and fruiting phase, and the finishing phase where the desired crop comprises orchid seeds. The growth cycle of a leafy vegetable such as lettuce or spinach may comprise only the rooting phase and the vegetative phase.

The term “nutrient” as used herein refers to the individual chemical, biochemical, organic extract, and symbiotic compounds which are required by a plant for growth or development or which optimize and stimulate plant growth and promote the desired characteristics of the plant.

The term “formula” as used herein refers to a list of nutrients in their designated proportions for a given genus, species, or strain of hydroponically-grown plant, as defined by a schedule, wherein the list of nutrients is used to define the nutrients of a formulation. The formula according to the schedule may change on a daily, weekly, biweekly, monthly, or other periodic basis, or may change according to the growth cycle of the plant.

The term “formulation” as used herein refers to a set of nutrients dispensed in their designed proportions according to the formula. The nutrient components of the formulation may be packaged together if they are members of a permitted combination. Member nutrients that comprise a restricted combination must be packaged separately from each other, but nay be packaged with other nutrients of a permitted combination.

The term “nutrient solution” as used herein refers to the full complement of individual nutrients or permitted combinations of nutrients of a formulation dissolved in a volume of water specified in the instructions provided with the formulation. According to the invention, one formulation of nutrients dissolved in one specified volume of water produces one batch of hydroponic nutrient solution.

The term “schedule” as used herein refers to the chronologically sequential timetable of formulae. As will be apparent to one skilled in the art, a schedule appropriate for one hydroponic growth cycle of a plant, such as that for the production of flowers, will differ from a schedule appropriate for another hydroponic growth cycle of the plant, such as that for the production of seeds, although the schedules may be similar or identical during, for example, the vegetative phases of both hydroponic growth cycles.

The term “nutrient lode” as used herein refers to a complete set of formulations according to a schedule. The nutrient lode comprises the entire nutrient profile for a complete hydroponic growth cycle.

The term “permitted combination” as used herein refers to a subset of the nutrients of a formulation which can be safely stored and packaged together as a dry mixture or as a solution in one container without adversely affecting the quality or shelf-life of the component nutrients of said permitted combination.

The term “restricted combination” as used herein refers to a subset of the nutrients of a formulation which cannot be safely stored together as a dry mixture or as a solution in one container without adversely affecting the quality or shelf-life of the component nutrients of said restricted combination. For example, the combination of beneficial bacteria and amino acids may comprise a restricted combination because, if stored as a solution in one container, said restricted combination may result in the depletion and/or rancidification of the ammo acids, as well as the untimely activation of the beneficial bacteria.

2. Nutrient Kit

Master Container

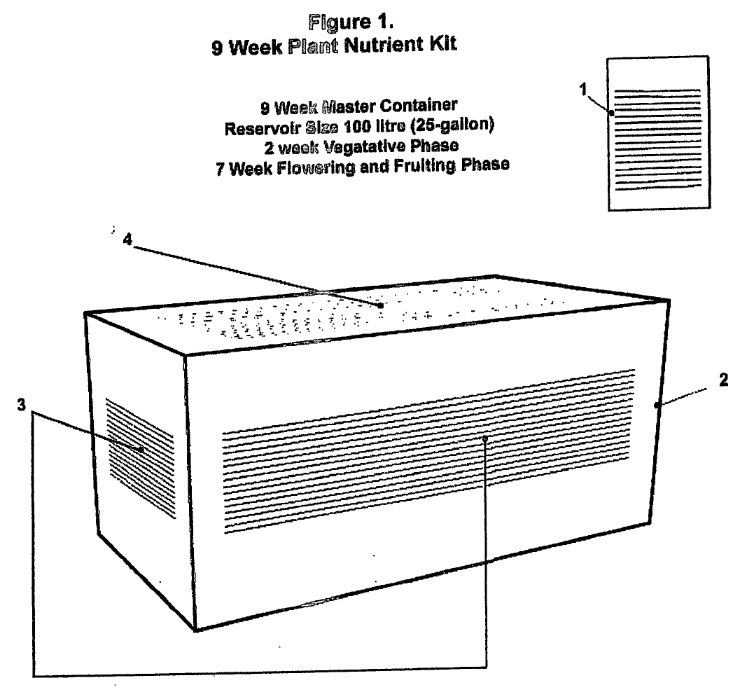

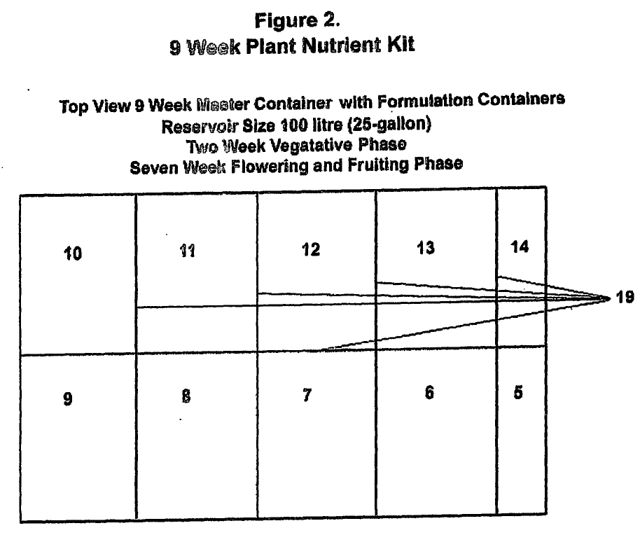

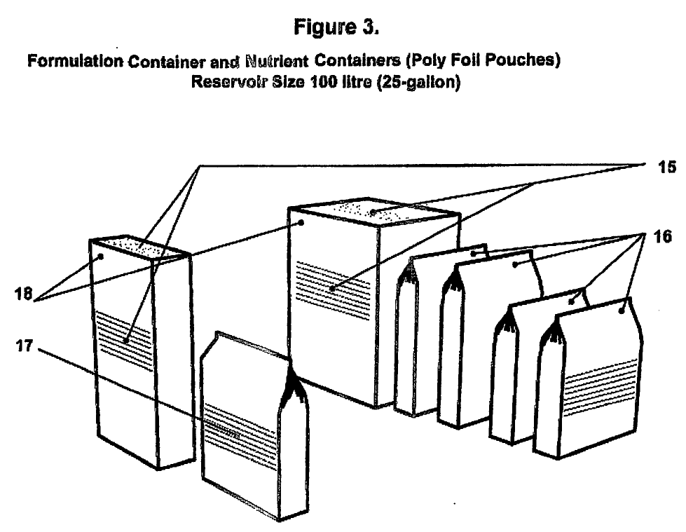

According to the present invention, there is provided a master container, which comprises the nutrient lode for a complete growth cycle according to a schedule. The master container may be a carton, box, bag, bottle, cylinder, envelope, jar, or other suitable container. The master container may be made of plastic, cardboard, hardboard, or any other suitable material. In one embodiment of the invention as illustrated in FIGS. 1, 2, and 3, the master container 2 is a cardboard box of sufficient dimension to contain the nutrient lode. It will be readily apparent to one skilled in the art that other master container shapes and compositions can be used without departing from the scope of the invention.

The contents of the master container may be configured in many different ways. In a preferred embodiment, the master container comprises a set of formulation containers 18, wherein each formulation container comprises one formulation according to a formula of a schedule, and the set of formulation containers comprises the nutrient lode according to the schedule. Optionally, the master container may further comprise a plurality of sub-containers, wherein each sub-container further comprises the set of formulation containers corresponding to one growth phase of the growth cycle.

In another embodiment, the master container further comprises a set of nutrient containers, wherein the set of rent containers comprises the nutrient lode according to the schedule. According to this embodiment, each of these nutrient containers is marked with a corresponding designation 17 according to the schedule. For example, where a nutrient solution is prepared on a weekly basis, the nutrient container is marked with a corresponding designation of the week, to distinguish it from a similar nutrient container for a different week.

Optionally, the master container may further comprise a plurality of dividers 19 that divide the space defined by the master container into a plurality of compartments 5-14, wherein each compartment is dimensioned to contain one formulation container or one set of nutrient containers.

Optionally, the master container may further comprise instructions 1 or other indicia to inform the hydroponic gardener of the method of preparing, applying, and changing nutrient solution. In one embodiment, the instructions or other indicia are printed, marked, embossed, or affixed to the master container. In another embodiment, the instructions or other indicia are printed, marked, or embossed onto a separate surface such as a sheet of paper and located within or associated to the master container.

Formulation Container

The formulation container of the present invention comprises a set nutrients dispensed in their designated proportions according to the corresponding formula of the schedule. The formulation container may be a carton, box, bag, bottle, cylinder, envelope, jar, or other suitable container. The formulation container may be made of plastic, cardboard, hardboard, glass, or any other suitable material. In one embodiment of the invention, the formulation container is a cardboard carton of sufficient dimension to contain the formulation. It will be readily apparent to one skilled in the art that other formulation container shapes and compositions can be used without departing from the scope of the invention.

The contents of the formulation container may be configured in many different ways. In one embodiment, the formulation container comprises a set of nutrient containers 16, wherein each nutrient container comprises one nutrient according to the formula, an the set of nutrient containers comprises the formulation. According to this embodiment, each of these formulation containers is marked with a corresponding designation 15 according to the schedule. In another embodiment, the formulation container comprises a set of nutrient containers, wherein each nutrient container comprises one permitted combination of nutrients, and the set of nutrient containers comprises the formulation. In yet another embodiment, the formulation container comprises a set of nutrient containers, wherein each nutrient container comprises either one nutrient or one permitted combination of nutrients, and the set of nutrient containers comprises the formulation.

Optionally, the formulation container may further comprise instructions or other indicia to inform the hydroponic gardener of the method of preparing nutrient solution from the formulation therein. In one embodiment, the instructions or other indicia are printed, marked, embossed, or affixed to the formulation container. In another embodiment, the instructions or other indicia are printed, marked, or embossed onto a separate surface and located within or associated to the formulation container.

Nutrient Container

The nutrients according to the formula are pre-measured, and are packaged separately, or in a permitted combination, in a container.

The nutrient container may be a carton, box, bag, bottle, cylinder, envelope, tube, jar or other suitable container. The nutrient container may be made of glass, plastic, cardboard, hardboard, or any other suitable material. In one embodiment of the invention, the nutrient container is a polyfoil bag of sufficient dimension to contain the nutrient, formulation. It will be readily apparent to one skilled in the art that other nutrient container shapes and compositions can be used without departing from the scope of the invention.

Optionally, the nutrient container further comprises pH buffering agents such as calcium carbonate and potassium bicarbonate, thereby adjusting the pH of the resultant nutrient solution into the optimal pH range, typically pH 5.5 to pH 6.5 once said nutrient solution is prepared.

Nutrients

The nutrient requirements of a plant are dependent on both the type of plant and the stage of its life cycle. The nutrients of the present invention are pre-measured into nutrient containers in quantities according to a formula of a schedule to coincide with the plant's nutrient requirements for its specific chronological age or stage of development. The nutrient profile according to the schedule may be progressively stronger, progressively weaker, flat (low, moderate, or high), progressively stronger then sustained then progressively weaker, progressively weaker then sustained then progressively stronger,

The nutrients of a formulation are pre-measured for a specific strength, as typically measured in either parts per million (ppm), percentage of dry weight, or percentage volume, for incorporation into a nutrient solution. Optionally, the instructions may provide additional or alternate methods for producing quarter strength, half strength, and three-quarter strength nutrient solution.

Optionally, the nutrients may be provided as concentrates or ready to use solution (RTU) foliar sprays in the formulation containers or in the master container. These foliar spray concentrates or RTU solutions comprise select nutrients known which nutrients can be plat through its foliage. A worker skilled in the art will know which nutrient can be efficiently applied by foliar sprays.

The nutrients according to the present invention may be provided as powders, pastes, or liquids. In one embodiment of the present invention, an all-powered formulation, comprising powdered nutrients such as macronutrients, micronutrients, carbohydrates, amino acids, enzymes, vitamins, hormones, yeast extracts, beneficial bacteria, beneficial fungi, organic ingredients and present invention, an all-liquid formulation is provided.

Instructions

The nutrient kit according to the present invention comprises instructions, which can be printed onto the surface of a master container, a formulation container, or a nutrient container, or may be provided as a separate sheet. While the formulations and schedules of the present invention are complex, the instructions are simple to follow and execute, and are designed to eliminate all guesswork and error from the production of a nutrient solution optimised to the plant and its stage of growth.

3. Method of Use

The method of use according to the present invention comprises the steps of selecting a master container on the basis of the desired growth cycle for the hydroponic crop, and, according to the schedule provided, preparing a nutrient solution on a periodic basis, the period also being provided by the instructions. The preparation of the nutrient solution comprises the steps of mixing into a volume of water defined by the instructions the component nutrients or nutrient mixes from a formulation container appropriate to the period, applying the nutrient solution to the hydroponic crop, and repeating the instructions in the next period.

The present invention can be used with a variety of hydroponic systems, including aeroponics, drip irrigation, flood and drain, wick, NFT systems and all other hydroponic growth systems. Furthermore, the present invention can be used with a variety of growing mediums, including rock-wool, sphagnum moss, leca, coir, lava rock, and conventional soil as well as other hydroponic growing mediums.

The invention being this described, it will be obvious that the same may be varied in many ways. Such ions are not to be regarded as a departure from the spirit and scope of the invention, and all such modifications as would be obvious to one skilled in the art are intended to be included within the scope of the following claims.

The following examples are not intended to limit the present invention in any manner.

4. Example

An exemplary schedule comprises two weekly feedings during a vegetative phase, followed by seven weekly feedings in a flowering phase. The nutrient components of the formulations according to this schedule are set out below. The quantities of the nutrients in the weekly formulations are set out in Table 1.

Nutrients

The nutrient components of the hydroponic nutrient feeding system of the present invention are:

(a) Macronutrients

(b) Micronutrients

(c) Beneficial Fungi

(d) Beneficial Bacteria

(e) Yeasts Extracts

(f) Carbohydrates

(g) Enzymes

(h) Amino Acids

(i) Hormones

(j) Vitamins

(k) Organic Ingredients

(l) Organic Extracts

(a) Macronutrients

The present invention contains macronutrients: ammonium sulphate, calcium carbonate, calcium chelate, calcium nitrate, magnesium phosphate, magnesium sulphate, mono potassium phosphate, potassium bicarbonate, potassium nitrate, potassium sulphate. Urea is used as an additional source of nitrogen. Urea gives an even, sustained feeding of nitrogen, that has to be broken down by microbial action but it is not a problem in the present invention due to the microbial organism that are supplied. Potassium silicate is used and delivers silicon to plants that strengthens the epidermal cell walls.

(b) Micronutrients

The present invention contains micronutrients: boron, colbalt, copper, iron, manganese, molybdenum and zinc. These are chelated with DPTA, EDTA, EDDHA, and proteinate.

(c) Beneficial Fungi

The present invention also uses, tricoderma, endo mycorrhizal, ecto mycorrhizal. A list of beneficial fungi is provided in Table 2. Tricoderma fungi are very aggressive beneficial fungi that out compete many pathogenic (disease causing) microorganisms responsible for root rot, phytophtora, pythium and fusarium. The other fungi are endomycorrhizal and ectomycorrhizal, they work in the following manner.

Mycorrhiza form a symbiotic relationship between a plant and a fungus—the fungus attached itself to the plant's roots and functions as an extended root system for the plant, by sending out “feeding tubes” called mycelia far into the soil and hydroponic growing medium.

This increases the surface area of the plant's roots, improves the absorption of water and nutrients which are shared with their host plant. Mycorrhiza can increase the absorptive surface area of the plant's root system by more than 700 percent.

Helping the plant to fight drought, high temperatures in growing mediums, heavy metals, organic and inorganic soil toxins and pH extremes. This is especially important in the case of phosphorus, that does not diffuse very well in water.

Since a fungus mycelium is only one cell thick, it can cover the territory in much more detail an the plate's roots can spread itself into soil or hydroponic growing medium, and work its way into wherever it needs to go. In return, the fungus gets carbohydrates from the plant.

Fungi form two kinds of mycorrhizae: those that penetrate the cell wall of the plant's root and those that do not. The ones that do not are called ectomycorrhizal; those that do are called endomycorrhizal or, more commonly today, VAM fungi.

Most ectomycorrhizal fungi are macrofungi, basidiomycetes such as boletes or grilled fungi. The mycelium of ectomycorrhizal fungi forms a sheath, or mantle, around the roots of the symbiont plant. From the mantle, a hyphal network called the Hartig net extends into the root, between the cells, usually just a few cells deep.

Most endomycorrhizal fungi are in the order Glomales, and their bodies are hypogeous, when they are large enough to be seen at all. Many of these fungi have no fruiting body at all, reproducing entirely by spores produced one at a time on the hyphae. The mycelium of endomycorrhizal fungi actually grows into the cells of the symbiont plant, producing highly branched structures (known as an arbuscule, or “little tree”) inside the cell wall but outside the plasma membrane.

The plasma membrane of the plant cell becomes wrapped around the arbuscule, providing lots of surface area for the exchange of nutrients between plant and fungus. The arbuscules only last a few days before they are dissolved and digested by the host plant, so they are constantly growing and dissolving in the roots of a plant with this type of mycorrhiza.

Endomycorrhizal fungi also form swollen end cells called vesicles, either between root cells or within the cell wall. These vesicles are thought to be storage locations for fungal food reserves.

The host plant has to give up 3% to 20% of its total carbohydrates produced to its mycorrhiza host. Giving up 3% to 20% that could be used for photosynthesis is a lot. However, the present invention supplies all the carbohydrates, protein and vitamins the beneficial fungi and beneficial bacteria need, so they don't have to make all the protein, carbohydrates and vitamins from inorganic building blocks, and so the plant can keep that 3% to 20% of carbohydrates.

(d) Beneficial Bacteria

The beneficial bacteria the present invention uses. A list of beneficial bacteria is provided in Table 3.

The present invention uses microbial colonization for the different hydroponic growing mediums and rhizosphere of the plant roots. The rhizosphere is a 2-3 mm zone around the roots. These beneficial bacteria and fungi make macronutrients and micronutrients very available in forms that plants can assimilate and use quickly.

Beneficial microorganisms can establish and colonize beneficial microbial life that create their own ecosystem so thoroughly that antagonistic and pathogenic bacteria and fungi cannot establish themselves onto or into root surfaces. Beneficial microorganisms are an integral part of the soil food web and are what makes soils “alive”.

Beneficial microorganisms in soil and hydroponic growing mediums break down and digest basic nutrient materials into forms available for immediate plant uptake, promoting stronger vigorous plants with rapid root growth and resistance to disease.

Using today's hydroponic growing mediums rock wool, expanded clay pellets, sphagnum moss mixes or other growing mediums for indoor gardening these beneficial micro organisms are not present in man-made growing mediums like they are in a true healthy soil eco-systems that are full of life and microbial diversity.

You can re-establish beneficial microbe colonization in your indoor garden as well as outdoor gardens. It's very simple if you colonize beneficial microorganisms into the root zone. The detramental microbes have literally no place to live and grow. Microbial colonization is known to suppress disease.

The present invention also provide rhizobacteria that fix nitrogen from the air, as well as bacteria that fix nitrogen in soils and hydroponic growing mediums.

The present invention also uses bacteria that solubalize phosphorus and still other bacteria that produce plant growth regulators that stimulate plant and root growth.

(e) Yeast Extracts

The present invention contains yeasts extracts. The present invention uses fermented yeasts: saccharmyces cerevistae, or S. fermentati. These yeasts provide B vitamins and amino acids, and they are also a source of cytokinins and protein. They are also a way of feeding bacteria with pre-made vitamins. Bacteria can make their own vitamins, but this takes time and slows growth.

(i) Carbohydrates

The present invention contains carbohydrates carbohydrates (carbon skeleton), mono saccharides of glucose, xylose, arabinose, galactose, fucose, and polysaccharide-dextrose, oligosaccharides-chitosan.

The present invention's use of polysaccharide dextrose is the food of choice for microbial colonization. The present invention also uses chitosan (Poly-D-Glucosamine) which is an oligosaccharide, which is also food for microbial colonization, as well as acting as a growth stimulant. Myo-inositol is used to speed up the Krebs Cycle through phospholipid pathways.

(g) Enzymes

The present invention uses enzymes. A list of enzymes useful in the preparation of the formulations of this invention is provided in Table 4. In plant life, plants and bacteria produce enzymes that are necessary for nutrients, proteins, minerals, amino acids, starches and carbohydrates to be broken down.

Enzymes can do in seconds and minutes that would take days and weeks to do in plants and bacteria. Enzymes take a short cut around the activation energy required for a reaction to occur. Some enzymes work inside of cells (intracellular) and some work outside the cell (extracellular).

All biochemical reactions are enzyme catalyzed. Enzymes are critical to all life. Enzymes are proteins, they are high molecular weight compounds made up principally of chains of amino acids linked together by peptide bonds.

In a plant, this catalyzes specific reactions of metabolism without itself being altered permanently, or destroyed. In other words, an enzyme is a protein that initiates specific catalytic action, but is not used up in the reaction.

An enzyme is a large protein molecule, many times larger in atomic mass than a water molecule. There are thousands of different types of enzymes that initiate, accelerate, or separate the various chemical reactions in living cells.

They are each very selective in the reactions they create. Living cells are made up of a complex system of chemical reactions, all of which must take place at carefully controlled rates.

The chemical reaction catalyzed by an enzyme is done so at a very specific location within the molecule. This is known as the active site, and the substance in which the reaction occurs is called the substrate. The basic structure of this process can be clarified what is known as the ‘lock and key’ model. The substrate (key) fits neatly into the enzyme (lock) to accommodate the chemical process, but only one kind of key can fit into the lock. Only one kind of substrate can fit into the active site of the enzyme.

The process under which the bonding of the substrate and enzyme take place is due to electrostatic forces involving a given molecule's polar magnetic forces of positive and negative charges. When the positive end of a molecule comes close to a negative end of another molecule, an attraction occurs. If the key fits the lock, a bond occurs.

Enzymes activity can be diminished or destroyed. If some other molecule Is able to bond to the active site and block the entry of the substrate. These substances are known as enzyme inhibitors.

While more than a thousand different enzymes have been identified, they have been general classified Into six categories. The “Oxyreductases” are enzymes that catalyze hydrogen transfer. “Hydrolases” catalyze the transfer of water elements at a specific site in the molecule. “Transferases” catalyze the transfer of all non-hydrogen atoms. “Lysases” contribute to many transport and regulatory processes involving metals, fatty acids, and hormones. “Isomerases” catalyze reactions involving structural rearrangement of molecules. “Ligases” work with DNA in catalyzing sugars and phosphates in cell replication.

Some of the commonly known enzymes used in agriculture are Protease, Amylase, Cellulase, and Pectinase. The micro-biological aspects of the soil system and subsequent plant growth process involve enormous quantities of bacteria and other micro-organisms.

The micro-organisms produce, and rely upon the catalytic processes of enzymes, and are therefore reliant upon sufficient quantities of the enzymes to multiply and provide the necessary means for breaking down the nutrients for plant uptake. In soil conditions where bacterium are limited, plant growth is inhibited.

This can be overcome by the addition of a properly balanced innoculation of an enzyme and bacteria package structured to balance the microbial community. Microorganism usually cannot take in large, protein molecules. They have to bring then into their cells, either as free amino acids or small peptides (small fragments of proteins). By electing to predigest protein with the use of protease enzymes, the bacteria do not have to secrete as many proteases into the growing medium to break down the protein, this speeds up beneficial bacteria growth.

This is a synergistic biological reaction which the present invention uses to enhance plant growth.

(h) Amino Acids

The preset invention contains amino acids. A list of amino acids useful in the preparation of the formulations of this invention is provided in Table 5. Additionally, gamma-amino-butyric-acid (GABA) is used as a growth enhancer. Plants use GABA as an adaptive response contributing to regulation of cytoplasmic pH and it also affords an alternative pathway for glutamate entry into the krebs cycle and plays a role in plant's defence system.

The present invention also contains N-Anetyl_Thiazolidin-4-Carboxilic acid, for promoting flowering and fruit setting.

(i) Hormones

The present invention contains hormones: The present invention also uses hormones, gibberellins, and cytokinins. There are 126 different gibberellins known. Gibberellins are believed to be synthesized in young tissues of the shoot and also the developing seed. It is uncertain whether young root tissues also produce gibberellins. There is also some evidence that leaves may be the source of some biosynthesis (Sponsel, 1995; Salisbury and Ross).

The Gibberellins the present invention uses are Ga3, Ga4, and Ga7. Active gibberellins show many physiological effects, each depending on the type of gibberellin present as well as the species of plant.

Gibberellins stimulate stem elongation by stimulating cell division and elongation. Also stimulates bolting/flowering in response to long days. Breaks seed dormancy in some plants which require stratification or light to induce germination. Gibberellins also induce maleness in dioecious flowers (sex expression). Can cause parthenocarpic (seedless) fruit development and can delay senescence in leaves and citrus fruits.

The present invention uses cytokinins. There are over 200 different cyctokinins known today. Cytokinin is generally found in higher concentrations in meristematic regions and growing tissues. They are synthesized in the roots and translocated via the xylem to shoots. Cytokinin biosynthesis happens through the biochemical modification of adenine. The Cytokinins in the present invention are 6-furfurylaminopurine, benzyladenine, and 6-benzyladenine and Forchlorfenuron.

The list of some of the known physiological effects caused by cytokinins are listed below. The response will vary, depending on the type of cytokinins and plant species (Davies, 1995; Mauseth, 1991; Raven, 1992; Salisbury and Ross, 1992). Cytokinins stimulate cell division as well as stimulating morphogenesis (shoot initiation/bud formation) in tissue culture. Cytokinins also stimulate the growth of lateral buds (release of apical dominance) and promotes leaf expansion resulting from cell enlargement. Cytokinins enhance stomatal opening in some species and promotes the conversion of etioplasts via stimulation of chlorophyll synthesis.

The present invention also uses brassinolides, salicylic acid and triacontanal. Brassinolide is a plant steroid discovered in arabadopis, and found in other plants such as the mustard family, as well as many other plat families. It plays a roll in cell elongation and cell division. Absence of brassinolides results in dwarf plants.

(j) Vitamins

The present invention contains vitamins: The present invention contains B-vitamins B-1 (thiamin mononitrate), B-2 (riboflavin), B-3 (nicotinic acid), B-5 (pantothemic acid), B-6 (pyridoxine), B-7 (biotin), B-9 (peteroyl-glutamic acid), B-12 (cyanocobamin).

These B-vitamins are important metabolites for optimum plant growth, flowering and fruiting. B-vitamins are pre-cursors to co-enzymes involved in energy production and the breakdown of proteins involved in the synthesis of nucleic acids and certain amino acids and help in cell division and play an important part in the mitochondria, helping in the respiration of the plant and carbohydrate metabolism.

(k) Organic Ingredients

The present invention contains organic ingredients: carboxylic acid. Citric acid is used to help unbind phosphorus and uses succinic acid to increase fruit set, retard stem elongation and increase yield.

The present invention contains citric acid. Organic acids, like citric acid, which increase the availability of phosphorus in soils and hydroponic growing mediums, mainly through both the decreased absorption of phosphates to soil and hydroponic growing mediums (phosphorus likes to bind to soils and growing mediums), and increased solubility of phosphorus compounds.

The present invention contains high phosphorus bat guano for an organic phosphorus and potassium source. The present invention contains seabird guano, for another organic source of nitrogen, phosphorus, potassium.

The present invention uses vermicompost (earthworm castings). This is an organic source of nitrogen, phosphorus, potassium, calcium, magnesium and micronutrients in an organic form that is easily absorbed by plants. Vermicompost also contains a high percentage of humus and enzymes.

The present invention also uses mono and ortho silicic acid that add 78 extra minerals and elements that plants do not get from standard hydroponic nutrients. A list of these minerals and elements is provided in Table 6.

Triacontanol increases flowering and fruiting yields, height of plants and yields. Earlier and stronger tillering, greener and broader leaves with an increase of photosynthesis. Increased nitrogen assimilation and longer stronger roots.

(l) Organic Extracts

The preset invention contains organic extracts: Casien hydrolysate and soy hydrolysate are a source of 21 proteinogenic amino acids:

Which are in the L-form. L-form amino acids are easily assimilated by plants. There are 21 important amino acids involved in plant functions. Amino acids are the components of proteins and enzymes which are basic cons and precursors of plant cell metabolism and are also involved in t-RNA (transfer ribonucleic acids) and DNA (deoxyribonucleic acid) synthesis.

Studies have proven that amino acids can directly or indirectly influence the physiological activates of plants. L-glutamic acid and L-aspartic acid, by transamination give rise to the rest of the amino acids, L-proline act mainly on the hydric balance of the plant strengthening the cellular walls in such a way that they increase resistance to unfavourable climate conditions.

L-alanine, L-valine, L-leucine improve fruit quality, L-histidine help in fruit ripening. L-methionine is a growth precursor that stabilizes the cell walls of microbial life, and is also a precursor of ethylene and growth factors such as espermine, an espermidine, which are synethesized from 5-adenosyl methionine, L-tryptophan is a precursor for auxin synthesis.

L-arginine induces synthesis of flowering and fruiting related hormones: L-glycine and L-glutamic are also fundamental metabolites in the formation process of plant tissue and chlorophyll-synthesis. They also help increase chlorophyll concentration in plants, leading to a higher degree of photosynthesis.

L-glycine, L-glutamic acid help keep stomates open. Stomates are the cellular structures that control the hydric balance of the plant, the macronutrient and micronutrient absorption and absorption of gases. The opening of stomates is controlled by both external factors—light, humidity, temperature and salt concentration—and internal factors—amino acid concentration, abcisic acid.

The stomates are closed when light and humidity are low and temperature and salt concentration are high. When stomates are closed, photosynthesis and transpiration are reduced (low absorption of macronutrients and micronutrients) and respiration is increased (carbohydrate destruction). In this case the metabolic balance of the plant is negative.

Catabolism is higher than anabolism. This implies slow metabolism and stops the plant growth.

L-glutamic acid acts as a cytoplasm osmotic agent of guard cells favouring the opening of stomates. L-glycine and L-glutamic acid are also very effective chelating agents of micronutrients making for easier, safer absorption and long distance transport inside the plant and easier cell membrane permeability.

The present invention also uses amino acids in L-form but also uses higher amounts of L-glutamic acid as a carrier for other amino acids. And increased amounts of L-cystine as a plant metabolizer and higher amounts of L-tryptophan to help increase flowering and fruit set.

The present invention also uses methanol—to help with plant absorption of all the nutrient components of the present invention.

The present invention also contains humic and fulvic acids. The preperation humic and fulvic acids is well known in the art. Both humic and fulvic acids have a similar chemical structure: their content in carbon ranges between 40 and 60% (being higher in the humic acids), and their content in oxygen ranges between 30% and 50% (higher in the fulvic acids). This higher oxygen content in the fulvic acids is due to oxygen groups (carboxyles, hydroxyphenols, hydroxyenols, hydroxyquinones, lactones, ethers, hydroxyalcohols) that are involved in the processes of metal chelation.

Humic and Fulvic acids also contain nitrogen (less than 1% in the fulvic acids, and around 5% in the humic acids). The groups that contain nitrogen are amine, imine, peptids, porphirines, etc. These groups also play a role in metal chelation.

However, most of the chelating power of the humic and fulvic acids is due to the carboxylic and hydroxyacid groups. This fact, together with the higher solubility of the fulvic acids, implies a much bigger chelating power of these acids compared to that of the humic acids.

Besides this, under certain conditions humic and fulvic acids improve the growth of the plants. This has been observed after foliar application, and also when applied to the water in hydroponic culture. It has also been proved that the application of humic and fulvic acids has a positive effect on root development in hydroponics.

Likewise, the humic substances have positive effects on the development of microbial species (bacteria, fungi, yeast), some of which are part of the soil flora. These effects are produced through several ways, being the most important to act as a food and energy reservoir for those microorganisms.

Some of the other ways are through the chelating power of the humic substances, that make metals available to the microorganisms and by modifying the cellular membranes in a similar way as giberellic acid acts. As well as through biochemical mechanisms, once the humic substances have entered the microorganisms.

The main characteristics that define and difference humic acids from fulvic acids are humic acids have a higher molecular weight (200000 to 300000). Are black or dark colour. Solublising in alkaline conditions and unsoluble in acid conditions. Humic have a great capacity of water retention. As well as colloidal action on clay soils. Having a high cationic exchange capacity with a very stable structure.

Fulvic acids have a lower molecular weight (2000 to 3000). As well as being pale yellow in colour with the ability to solublising in both acid and alkaline conditions. It is the strongest electrolyte known and has a lower capacity of water retention then humic acid. Fulvic Acid has a lower capacity of cationic exchange and is not a very stable structure. However it has a very chelating power, a great stimulating effect on plants and on soil microbial fauna and flora. Fulvic acid also produces CO2 when oxidized.

As a result of these characteristics and differences between humic and fulvic acids, we can say that the humic acids act mainly on the physical and chemical reactions of the soil, and the fulvic acids do it on the biological and chemical reactions.

The physical effects of humic acids is better clay dispersion in compact soils and cohesion of sandy soils. As well as increase in soil permeability. Thus increase in the soil capacity for water retention and the reduction of water evaporation.

The chemical effects of fulvic acid is the increase in the capacity of cationic exchange. The transporting of microelements to the plant roots. Easier absorption of marconutrients. As well as chelating effect on Fe, Mn, Zn, Cu and B. Fulvics also reduction of soil salinity by sequestering Na+. Some components of fulvic acids are metabolized by the plant and production of C02 when oxidized, favoring the photosynthesis.

The biological effects of humic and fulvic acids are better development of microbial colonies, soil microbial flora stimulation, seed germination, root development, and synthesis of nucleic acids. Improvement of plant and fruit quality with increased crop yields.

When humic and fulvic acids are applied to soil and hydroponic growing mediums, they Improve its physical, chemical, and biological properties. They also contribute to a better equilibrium of the soil and hydroponic nutrient solution.

The humic and fulvic acids constitute complexes with the soil cations, thus avoiding their immobilization. They act on the mineral compounds by unblocking the elements. They reduce the loss of fertilizers with lixiviation waters by fixing them. They stimulate the native microbial flora, thus soil fertility is increased. They improve the root system of the plant. They increase the cell permeability, thus Improving the absorption of nutrients.

The humic acids have a greater positive effect on soil properties and root structure. The fulvic acids have this positive effect more on plant nutrition, and also acting as plant metabolism stimulators. Humic acids have a long term action and fulvic acids have a more immediate action.

The present invention also contains L-ascorbic acid that promotes xylem formation. Additionally, it acts as a metabolic by scavenging free radicals, and thereby protecting plant cells from damage.

The present invention also contains ethanol extract of medicago sativa (alfalfa). Medicago sativa is rich in phytochemicals and phytohormones that stimulate plant grow. A list of the components of medicago sativa (alfalfa) is provided in Table 7.

The present invention contains alkaline hydrolysis extracts of ascophyllum nodosum (kelp). A list of the components of ascophyllum nodosum (kelp) is provided in Table 8. Ascophyllum nodosum is rich in minerals, vitamins, carbohydrates and phytohormones of different cytokinin varieties that are very strong growth promoters.

Ascophyllum nodosum seaweed extract, made by alkaline hydrolysis, is a natural plant growth regulator. Plant growth regulators are materials which control the growth and developments of plants. These substances are present in small quantities, generally in range of parts per million (ppm) or even parts per billion (ppb).

The main growth regulators which promote plant growth are the auxins, hormones, indoles and cytokinins. Cytokinins, are cell division factors which were first discovered in rapidly dividing cells during the 1950's. The indole compounds are naturally occurring plant growth promoters for root development and bud initiation.

The major plant growth promoters in Ascophyllum nodosum are cytokinins. Adenine and Zeatin are the majior or cytokinins present in Ascophyllum nodosum. Zeatin is the most biologically active cytokinin known. Adenine exhibits lower activity. Gas liquid chromatographic analysis that adenine (6-Aminopurine), kinetin (6-furfurylaminopurine) and zeatin and 6-benzylaminopurine are present. The method of preparation of Ascophyllum nodosum is known to workers skilled in the art. The following are compounds of Ascophyllum nodosum.

The present invention contains yucca shidigera (yucca) extract. It increases water and soil penetration and acts as a stress relief agent. Yucca extract has natural steroidal action by saponins and increases cell wall permeability and helps increase microbial populations and helps bid ammo acids and binds ammonia and acts as a natural surfactant. Numerous studies have been done in France by (Balansand and Pellessier), California Institute of Technology, University of California Davis, Carnoy Institute of Plant Physiology (Belgium), University of Kentucky and University of Miami.

The present invention also contains hydrolysed fish extract. It is rich in enzymes and plant nutrients in an organic form of nitrogen, phosphorus and potassium and micronutrients good for microbial colonization.

Salicylic Acid is known to activate defense genes against pathogen invaders. Salicyclic Acid aphenolic extract from willow bank, was long used as an analgesic.

The monosaccharide carbohydrates are used by the plant's respiration cycle and are crucial for shorter and enhanced Krebs cycle and larger energy (sinks) reserves during flowering and fruiting and the formation of hemicellulose to build cell walls or with nitrogen, to make proteins. Plants also use these carbohydrates to produce oils. They are directly or indirectly involved in almost all precursors of plant metabolites. Pyroligneous acid is used as a transfectant to these carbohydrates.

The total strength of the nutrient formula measured in ppm of the weekly, vegetative containers could be 600 ppm to 2500 ppm (depending on plant variety), with 800 to 1400 ppm being the average, and the ppm of the flowering and fruiting weekly containers could be 500 ppm to 3000 ppm, with 1000 ppm to 2400 ppm being the average spread for flowering and fruiting.

This will vary depending on the variety and which week of flowering and fruiting the plant is in. The vegetative, flowering and fruiting main container will be set up to accommodate the many varieties of plants, that have different lengths of a vegetative and flowering and fruiting periods with the vegetative period being. 1-10 weeks, with 1-3 weeks being the average for the vegetative period. Additionally, a flowering period of 6-16 weeks, with 7-9 weeks being the average, and reservoir sizes from 20 litres (5 gallons) to 4000 litres (1000 gallons), with 100 L(25 Gals) to 400 L(100 Gals) being the average. Various feeding method and system are listed in Table 9.

TABLE 1
Nine Plant Nutrient Kit 2 week Vegetative Phase/7 week Flowering & Fruiting Phase 100 L Reservoir

| | | | g/100 L | g/100 L | g/100 L | g/100 L | g/100 L | g/100 L | g/100 L |
|---|---|---|---|---|---|---|---|---|---|
| | g/100 L | g/100 L | Week 1 | Week 2 | Week 3 | Week 4 | Week 5 | Week 6 | Week 7 |
| | Week 1 | Week 2 | Flowering | Flowering | Flowering | Flowering | Flowering | Flowering | Flowering |
| | Vegetative | Vegetative | & Fruiting | & Fruiting | & Fruiting | & Fruiting | & Fruiting | & Fruiting | & Fruiting |
| | Phase | Phase | Phase | Phase | Phase | Phase | Phase | Phase | Phase |
| CaNO3 | 38.677 | 38.677 | 33.15 | 35.338 | 37.559 | 39.78 | 33.15 | 26.52 | |
| Urea | 24.342 | 24.342 | 18.15 | 19.348 | 20.564 | 21.78 | 18.15 | 14.52 | |
| KNO3 | 49.84 | 49.84 | 50.2 | 53.513 | 56.877 | 60.24 | 61.4 | 49.12 | |
| MKP | 27.66 | 27.66 | 80.2 | 39.016 | 41.468 | 43.92 | 41.4 | 33.12 | |
| MgPO4 | 1.7 | 1.7 | 1.7 | 1.8122 | 1.9261 | 2.04 | 12.9 | 10.32 | |
| MAP | 0 | 0 | 0.85 | 0.9061 | 0.9631 | 1.02 | 0.85 | 0.68 | |
| Epsom | 13.22 | 13.22 | 13.22 | 14.093 | 14.978 | 15.864 | 13.22 | 10.576 | |
| MgNOS | 11.05 | 11.05 | 11.05 | 11.779 | 12.52 | 13.26 | 22.25 | 17.8 | |
| Humic Acid | 105 | 105 | 105 | 111.93 | 118.97 | 126 | 105 | 84 | |
| Fulvic Acid | 101.25 | 101.25 | 101.25 | 107.93 | 114.72 | 121.5 | 101.47 | 81.176 | |
| Dextrose | 10 | 10 | 10 | 10.66 | 11.33 | 12 | 10 | 8 | |
| Glucose | 18 | 18 | 18 | 19.188 | 20.394 | 21.6 | 18 | 14.4 | |
| Xylose | 9 | 9 | 9 | 9.594 | 10.197 | 10.8 | 12 | 9.6 | |
| Arabinose | 1.5 | 1.5 | 1.5 | 1.56 | 1.67 | 1.78 | 1.5 | 1.2 | |
| Galactose | 0.6 | 0.6 | 0.6 | 0.64 | 0.69 | 0.72 | 0.6 | 0.48 | |
| Fucose | 0.9 | 0.9 | 0.9 | 0.96 | 1.02 | 1.08 | 1.2 | 0.96 | |
| Kelp | 2.1 | 2.1 | 2.1 | 2.2386 | 2.3793 | 2.52 | 2.1 | 1.68 | |
| Na Benzoate | 1.05 | 1.05 | 1.05 | 1.1193 | 1.1897 | 1.26 | 1.05 | 0.84 | |
| Fish Extract | 0.4 | 0.4 | 0.4 | 0.4264 | 0.4532 | 0.48 | 0.4 | 0.32 | |
| Thiamine HCl | 0.75 | 0.75 | 0.75 | 0.7995 | 0.8498 | 0.9 | 0.75 | 0.6 | |
| Riboflavin | 0.25 | 0.25 | 0.25 | 0.2665 | 0.2833 | 0.3 | 0.25 | 0.2 | |
| Nicotinic acid | 0.125 | 0.125 | 0.125 | 0.1333 | 0.1416 | 0.15 | 0.125 | 0.1 | |
| Calcium Carbonate | 0.0625 | 0.0625 | 0.0625 | 0.0667 | 0.0708 | 0.075 | 0.0625 | 0.05 | |
| Pottasium Carbonate | 0.0625 | 0.0625 | 0.0625 | 0.0667 | 0.0708 | 0.075 | 0.0625 | 0.05 | |
| Pyridoxine | 0.125 | 0.125 | 0.125 | 0.1333 | 0.1416 | 0.15 | 0.125 | 0.1 | |
| Pyroligneous Acid | 0.15 | 0.15 | 0.15 | 0.15 | 0.15 | 0.15 | 0.15 | 0.15 | |
| Biotin | 0.125 | 0.125 | 0.125 | 0.125 | 0.125 | 0.125 | 0.125 | 0.125 | |
| Peteroyl Glutamic Acid | 0.125 | 0.125 | 0.125 | 0.125 | 0.125 | 0.125 | 0.125 | 0.125 | |
| Cyanocobalamine | 0.125 | 0.125 | 0.125 | 0.125 | 0.125 | 0.125 | 0.125 | 0.125 | |
| Bat Guano extract | 0.2 | 0.2 | 0.2 | 0.2132 | 0.2266 | 0.24 | 0.2 | 0.16 | |
| Seabird Guano extract | 0.2 | 0.2 | 0.2 | 0.2132 | 0.2266 | 0.24 | 0.2 | 0.16 | |
| Earthworm Castings extract | 0.2 | 0.2 | 0.2 | 0.2132 | 0.2266 | 0.24 | 0.2 | 0.16 | |
| Leonardite | 0.1 | 0.1 | 0.1 | 0.1066 | 0.1133 | 0.12 | 0.1 | 0.08 | |
| Ascorbic Acid | 0 | 0 | 0 | 1.7056 | 1.8128 | 1.92 | 0.22 | 0.176 | |
| Casien/Soy Hydrolysate | 0 | 0 | 33.15 | 35.338 | 37.559 | 39.78 | 33.15 | 26.52 | |
| Citric Acid | 0.05 | 0.05 | 18.15 | 19.348 | 20.564 | 21.78 | 18.15 | 14.52 | |
| Sulfate of Potash | 0 | 0 | 50.2 | 53.513 | 56.877 | 60.24 | 61.4 | 49.12 | |
| Fe (total chelated) | 0.208 | 0.208 | 80.2 | 39.016 | 41.468 | 43.92 | 41.4 | 33.12 | |
| Mn (total chelated) | 0.14 | 0.14 | 1.7 | 1.8122 | 1.9261 | 2.04 | 12.9 | 10.32 | |
| Zn (total chelated) | 0.054 | 0.054 | 0.85 | 0.9061 | 0.9631 | 1.02 | 0.85 | 0.68 | |
| Cu (total chelated) | 0.003 | 0.003 | 13.22 | 14.093 | 14.978 | 15.864 | 13.22 | 10.576 | |
| B (total chelated) | 0.039 | 0.039 | 11.05 | 11.779 | 12.52 | 13.26 | 22.25 | 17.8 | |
| Mo (total chelated) | 0.002 | 0.002 | 105 | 111.93 | 118.97 | 126 | 105 | 84 | |
| Co (total chelated) | 0.0005 | 0.0005 | 0.0005 | 0.0005 | 0.0005 | 0.0005 | 0.0005 | 0.0005 | |
| EDTA | 1.25 | 1.25 | 0 | 0 | 0 | 0 | 0 | 0 | |
| DTPA | 0.387 | 0.387 | 18 | 19.188 | 20.394 | 21.6 | 18 | 14.4 | |
| EDDHA | 0.387 | 0.387 | 9 | 9.594 | 10.197 | 10.8 | 12 | 9.6 | |
| L-Alanine | 0.0043 | 0.0043 | 0.0043 | 0.0046 | 0.0049 | 0.0052 | 0.0043 | 0.0034 | |
| L-Arginine | 0.0076 | 0.0076 | 0.0076 | 0.0081 | 0.0086 | 0.0091 | 0.0076 | 0.0061 | |
| L-Aspargine | 0.0076 | 0.0076 | 0.0076 | 0.0081 | 0.0086 | 0.0091 | 0.0076 | 0.0061 | |
| L-Aspartic Acid | 0.0116 | 0.0116 | 0.0116 | 0.0124 | 0.0131 | 0.0139 | 0.0116 | 0.0093 | |
| L-Cystine | 100 | 0.0026 | 0.0026 | 0.0028 | 0.0029 | 0.0031 | 0.0026 | 0.0021 | |
| L-Cysteine | 0.0013 | 0.0013 | 0.0013 | 0.0014 | 0.0015 | 0.0016 | 0.0013 | 0.001 | |
| L-Glutamine | 0.0044 | 0.0044 | 0.0044 | 0.0047 | 0.005 | 0.0053 | 0.0044 | 0.0035 | |
| L-Glutamic Acid | 0.0091 | 0.0091 | 0.0091 | 0.0097 | 5 | 5 | 5 | 5 | |
| L-Glycine | 0.0042 | 0.0042 | 0.0042 | 0.0045 | 0.0048 | 0.005 | 0.0042 | 0.0034 | |
| L-Histidine | 0.0026 | 0.0026 | 0.0026 | 0.0028 | 0.0029 | 0.0031 | 0.0026 | 0.0021 | |
| L-Isoleucine | 0.0049 | 0.0049 | 0.0049 | 0.0052 | 0.0056 | 0.0059 | 0.0049 | 0.0039 | |
| L-Leucine | 0.0082 | 0.0082 | 0.0082 | 0.0087 | 0.0093 | 0.0098 | 0.0082 | 0.0066 | |
| L-Lysine | 0.0063 | 0.0063 | 0.0063 | 0.0067 | 0.0071 | 0.0076 | 0.0063 | 0.005 | |
| L-Methionine | 0.0013 | 0.0013 | 0.0013 | 0.0014 | 0.0015 | 0.0016 | 0.0013 | 0.001 | |
| L-Phenylalanine | 0.0052 | 0.0052 | 0.0052 | 0.0055 | 0.0059 | 0.0062 | 0.0052 | 0.0042 | |
| L-Proline | 0.0051 | 0.0051 | 0.0051 | 0.0054 | 0.0058 | 0.0061 | 0.0051 | 0.0041 | |
| L-Serine | 0.0052 | 0.0052 | 0.0052 | 0.0055 | 0.0059 | 0.0062 | 0.0052 | 0.0042 | |
| L-Threonine | 0.0037 | 0.0037 | 0.0037 | 0.0039 | 0.0042 | 0.0044 | 0.0037 | 0.003 | |
| L-Tryptophan | 0.0014 | 0.0014 | 5 | 0.0015 | 0.0016 | 0.0017 | 0.0014 | 0.0011 | |
| L-Tyrosine | 0.0038 | 0.0038 | 0.0038 | 0.0041 | 0.0043 | 0.0046 | 0.0038 | 0.003 | |
| L-Valine | 0.005 | 0.005 | 0.005 | 0.0053 | 0.0057 | 0.006 | 0.005 | 0.004 | |
| Barium Oxide | 0.0002 | 0.0002 | 0.0002 | 0.0002 | 0.0002 | 0.0002 | 0.0002 | 0.0002 | |
| Calcium Oxide | 0.01 | 0.01 | 0.01 | 0.01 | 0.01 | 0.01 | 0.01 | 0.01 | |
| Carbon | 0.2 | 0.2 | 0.2 | 0.2 | 0.2 | 0.2 | 0.2 | 0.2 | |
| Aceatic Add | 0.1 | 0.1 | 0.1 | 0.1 | 0.1 | 0.1 | 0.1 | 0.1 | |
| Ferric Oxide | 1.5 | 1.5 | 1.5 | 1.5 | 1.5 | 1.5 | 1.5 | 1.5 | |
| Magnesium Oxide | 1.11 | 1.11 | 1.11 | 1.11 | 1.11 | 1.11 | 1.11 | 1.11 | |
| Manganese Oxide | 0.97 | 0.97 | 0.97 | 0.97 | 0.97 | 0.97 | 0.97 | 0.97 | |
| Silica Oxide | 3.8 | 3.8 | 3.8 | 3.8 | 3.8 | 3.8 | 3.8 | 3.8 | |
| Sodium Oxide | 1.2 | 1.2 | 1.2 | 1.2 | 1.2 | 1.2 | 1.2 | 1.2 | |
| Strontium Oxide | 0.001 | 0.001 | 0.001 | 0.001 | 0.001 | 0.001 | 0.001 | 0.001 | |
| Titanium Dioxide | 0.02 | 0.02 | 0.02 | 0.02 | 0.02 | 0.02 | 0.02 | 0.02 | |
| Chlorine | 4.6 | 4.6 | 4.6 | 4.6 | 4.6 | 4.6 | 4.6 | 4.6 | |
| Fluorine | 0.09 | 0.09 | 0.09 | 0.09 | 0.09 | 0.09 | 0.09 | 0.09 | |
| Antimony | 0.003 | 0.003 | 0.003 | 0.003 | 0.003 | 0.003 | 0.003 | 0.003 | |
| Arsenic | 0.009 | 0.009 | 0.009 | 0.009 | 0.009 | 0.009 | 0.009 | 0.009 | |
| Beryllium | 0.021 | 0.021 | 0.021 | 0.021 | 0.021 | 0.021 | 0.021 | 0.021 | |
| Bismuth | 0.008 | 0.008 | 0.008 | 0.008 | 0.008 | 0.008 | 0.008 | 0.008 | |
| Bromine | 0.053 | 0.053 | 0.053 | 0.053 | 0.053 | 0.053 | 0.053 | 0.053 | |
| Cadmium | 0.002 | 0.002 | 0.002 | 0.002 | 0.002 | 0.002 | 0.002 | 0.002 | |
| Cerium | 1.4 | 1.4 | 1.4 | 1.4 | 1.4 | 1.4 | 1.4 | 1.4 | |
| Cesium | 0.11 | 0.11 | 0.11 | 0.11 | 0.11 | 0.11 | 0.11 | 0.11 | |
| Chromium | 0.049 | 0.049 | 0.049 | 0.049 | 0.049 | 0.049 | 0.049 | 0.049 | |
| Dysprosium | 0.024 | 0.024 | 0.024 | 0.024 | 0.024 | 0.024 | 0.024 | 0.024 | |
| Erbium | 0.009 | 0.009 | 0.009 | 0.009 | 0.009 | 0.009 | 0.009 | 0.009 | |
| Gadolinium | 0.012 | 0.012 | 0.012 | 0.012 | 0.012 | 0.012 | 0.012 | 0.012 | |
| Gallium | 0.12 | 0.12 | 0.12 | 0.12 | 0.12 | 0.12 | 0.12 | 0.12 | |
| Germanium | 0.012 | 0.012 | 0.012 | 0.012 | 0.012 | 0.012 | 0.012 | 0.012 | |
| Gold | 5E−05 | 5E−05 | 5E−05 | 5E−05 | 5E−05 | 5E−05 | 5E−05 | 5E−05 | |
| Hafnium | 0.042 | 0.042 | 0.042 | 0.042 | 0.042 | 0.042 | 0.042 | 0.042 | |
| Holmium | 0.003 | 0.003 | 0.003 | 0.003 | 0.003 | 0.003 | 0.003 | 0.003 | |
| Indium | 0.0003 | 0.0003 | 0.0003 | 0.0003 | 0.0003 | 0.0003 | 0.0003 | 0.0003 | |
| Iodine | 0.019 | 0.019 | 0.019 | 0.019 | 0.019 | 0.019 | 0.019 | 0.019 | |
| Lead | 0.038 | 0.038 | 0.038 | 0.038 | 0.038 | 0.038 | 0.038 | 0.038 | |
| Lithium | 0.16 | 0.16 | 0.16 | 0.16 | 0.16 | 0.16 | 0.16 | 0.16 | |
| Lutetium | 0.003 | 0.003 | 0.003 | 0.003 | 0.003 | 0.003 | 0.003 | 0.003 | |
| Mercury | 0.0005 | 0.0005 | 0.0005 | 0.0005 | 0.0005 | 0.0005 | 0.0005 | 0.0005 | |
| Niobium | 0.26 | 0.26 | 0.26 | 0.26 | 0.26 | 0.26 | 0.26 | 0.26 | |
| Nickel | 0.011 | 0.011 | 0.011 | 0.011 | 0.011 | 0.011 | 0.011 | 0.011 | |
| Niobium | 0.26 | 0.26 | 0.26 | 0.26 | 0.26 | 0.26 | 0.26 | 0.26 | |
| Praseodymium | 0.11 | 0.11 | 0.11 | 0.11 | 0.11 | 0.11 | 0.11 | 0.11 | |
| Rubidium | 2.08 | 2.08 | 2.08 | 2.08 | 2.08 | 2.08 | 2.08 | 2.08 | |
| Ruthenium | 0.0001 | 0.0001 | 0.0001 | 0.0001 | 0.0001 | 0.0001 | 0.0001 | 0.0001 | |
| Samarium | 0.0049 | 0.0049 | 0.0049 | 0.0049 | 0.0049 | 0.0049 | 0.0049 | 0.0049 | |
| Scandium | 0.001 | 0.001 | 0.001 | 0.001 | 0.001 | 0.001 | 0.001 | 0.001 | |
| Selenium | 0.0006 | 0.0006 | 0.0006 | 0.0006 | 0.0006 | 0.0006 | 0.0006 | 0.0006 | |
| Silver | 0.0005 | 0.0005 | 0.0005 | 0.0005 | 0.0005 | 0.0005 | 0.0005 | 0.0005 | |
| Tantalum | 0.0007 | 0.0007 | 0.0007 | 0.0007 | 0.0007 | 0.0007 | 0.0007 | 0.0007 | |
| Terbium | 0.0006 | 0.0006 | 0.0006 | 0.0006 | 0.0006 | 0.0006 | 0.0006 | 0.0006 | |
| Thallium | 0.025 | 0.025 | 0.025 | 0.025 | 0.025 | 0.025 | 0.025 | 0.025 | |
| Thorium | 0.96 | 0.96 | 0.96 | 0.96 | 0.96 | 0.96 | 0.96 | 0.96 | |
| Thulium | 0.0002 | 0.0002 | 0.0002 | 0.0002 | 0.0002 | 0.0002 | 0.0002 | 0.0002 | |
| Tin | 0.004 | 0.004 | 0.004 | 0.004 | 0.004 | 0.004 | 0.004 | 0.004 | |
| Tungsten | 0.21 | 0.21 | 0.21 | 0.21 | 0.21 | 0.21 | 0.21 | 0.21 | |
| Vanadium | 0.062 | 0.062 | 0.062 | 0.062 | 0.062 | 0.062 | 0.062 | 0.062 | |
| Ytterbium | 0.006 | 0.006 | 0.006 | 0.006 | 0.006 | 0.006 | 0.006 | 0.006 | |
| Yttrium | 0.18 | 0.18 | 0.18 | 0.18 | 0.18 | 0.18 | 0.18 | 0.18 | |
| Zirconium | 0.42 | 0.42 | 0.42 | 0.42 | 0.42 | 0.42 | 0.42 | 0.42 | |
| Alfalfa Extract | 0.2 | 0.2 | 0.2 | 0.2132 | 0.2266 | 0.24 | 0.2 | 0.16 | |

The following are components of alfalfa extract. No values are
available for alfalfa extract phyto chemicals and phyto hormones.

| | | |
|---|---|---|
| 3-Methoxycoumestrol | Erepsin | Pectinase |
| 3-Methylbutanol | Folacin | Pentanal |
| 0-Methylcoumestrol | Formononetin | Peroxidase |
| 4-Arnino-Butyric-Acid | Genistein | Phaeophorbide-A |
| 11,12-Dimethoxy | Guanine | Propanal |
| 7-Hydroxycoumestin | Guanosine | Pyridoxine |
| Acetone | Hederaginin | Quinic-Acid |
| Adenine | Hentriacontane | Ribose |
| Adenosine | Hydrogen cyssnide | saponin |
| Alfalfone | Hypoxanthine | Sativol |
| Aipha-Spinasterol | Inosine | shikimic-Acid |
| Alpha-Tocopherol | Inositol | Soyasapogenols |
| Amylase | Invertase | Stachydrine |
| Arabinose | Isocytosine | Stigmasterol |
| Beta-sitosterol | L-Homostachydrine | Succinic-Acid |
| Betaine | L-stachydrine | Tannin |
| Biochanin-A | Limonene | Triacontanol |
| Butanone | Lucernol | Tricin |
| Calcium | Lutein | Trifoliol |
| Campesterol | Malic Acid | Trigonelline |
| chlorophyllide-A | Malonic Acid | Trimethylamine |
| Choline | Medicagenic Acid | Tryptophan |
| Coagulase | Medicagol | violaxanthin |
| Coumestrol | Myristone | Vitamine E |
| Cryptoxanthin | Neoxanthin | Vitamine K |
| Cycloartenol | Niacin | Xanthophylls |
| Cytidine | Octacosanol | zeaxanthin |
| Daidzen | Oxalic | |
| Daphnoretin | Petin | |

| | | | g/100 L | g/100 L | g/100 L | g/100 L | g/100 L | g/100 L | g/100 L |
|---|---|---|---|---|---|---|---|---|---|
| | g/100 L | g/100 L | Week 1 | Week 2 | Week 3 | Week 4 | Week 5 | Week 6 | Week 7 |
| | Week 1 | Week 2 | Flowering | Flowering | Flowering | Flowering | Flowering | Flowering | Flowering |
| | Vegetative | Vegetative | & Fruiting | & Fruiting | & Fruiting | & Fruiting | & Fruiting | & Fruiting | & Fruiting |
| | Phase | Phase | Phase | Phase | Phase | Phase | Phase | Phase | Phase |
| Mannitol | 0.208 | 0.208 | 0.208 | 0.2217 | 0.2357 | 0.2496 | 0.208 | 0.1664 | |
| Larninarin | 0.14 | 0.14 | 0.14 | 0.1492 | 0.1586 | 0.168 | 0.14 | 0.112 | |
| Carotene | 0.054 | 0.054 | 0.054 | 0.0576 | 0.0612 | 0.0648 | 0.054 | 0.0432 | |
| Tocopherols | 0.003 | 0.003 | 0.003 | 0.0032 | 0.0034 | 0.0036 | 0.003 | 0.0024 | |
| Non-ionic Alkoxalate | 0.039 | 0.039 | 0.039 | 0.0416 | 0.0442 | 0.0468 | 0.039 | 0.0312 | |
| Methanol | 0.002 | 0.002 | 0.002 | 0.0021 | 0.0023 | 0.0024 | 0.002 | 0.0016 | |
| Saccharmyces cerevistae | 0.0005 | 0.0005 | 0.0005 | 0.0005 | 0.0005 | 0.0005 | 0.0005 | 0.0005 | |
| Saccharmyces | 0.0005 | 0.0005 | 0.0005 | 0.0005 | 0.0005 | 0.0005 | 0.0005 | 0.0005 | |
| Fermentati | | | | | | | | | |
| Polygalacturonase | 1.4 | 1.4 | 1.4 | 1.4 | 1.4 | 1.4 | 1.4 | 1.4 | |
| Endo-1,4-betaxylanese | 8-uoa | 8-uoa | 8-uoa | 8-uoa | 8-uoa | 8-uoa | 8-uoa | 8-uoa | |
| Protease | 14-uoa | 14-uoa | 14-uoa | 14-uoa | 14-uoa | 14-uoa | 14-uoa | 14-uoa | |
| Esterase | 6-uoa | 6-uoa | 6-uoa | 6-uoa | 6-uoa | 6-uoa | 6-uoa | 6-uoa | |
| Lipase | 9-uoa | 9-uoa | 9-uoa | 9-uoa | 9-uoa | 9-uoa | 9-uoa | 9-uoa | |
| Glycosylase | 11-uoa | 11-uoa | 11-uoa | 11-uoa | 11-uoa | 11-uoa | 11-uoa | 11-uoa | |
| Nitrate reductase | 8-uoa | 8-uoa | 8-uoa | 8-uoa | 8-uoa | 8-uoa | 8-uoa | 8-uoa | |
| Chitosan | 0.0003 | 0.0003 | 0.0003 | 0.0003 | 0.0003 | 0.0003 | 0.0003 | 0.0003 | |
| Thiazolidin-4-Carboxolic Acid | 0.019 | 0.019 | 0.019 | 0.019 | 0.019 | 0.019 | 0.019 | 0.019 | |
| Salicylic Acid | 0.038 | 0.038 | 0.038 | 0.038 | 0.038 | 0.038 | 0.038 | 0.038 | |
| GA4 | 0.16 | 0.16 | 0.16 | 0.16 | 0.16 | 0.16 | 0.16 | 0.16 | |
| GA7 | 0.003 | 0.003 | 0.003 | 0.003 | 0.003 | 0.003 | 0.003 | 0.003 | |
| Brassinolide Myoinsitol | 0.01 | 0.01 | 0.01 | 0.01 | 0.01 | 0.01 | 0.01 | 0.01 | |
| Gaba | 0.0102 | 0.0102 | 0.0102 | 0.0102 | 0.0102 | 0.0102 | 0.0102 | 0.0102 | |
| 6-Furfurylaminopurine | 0.01 | 0 | 0.01 | 0.01 | 0.01 | 0.01 | 0.01 | 0.01 | |
| 1-Naphthaleneacetic Acid | 0.026 | 0 | 0 | 0 | 0 | 0 | 0 | 0 | |
| Benzyladenine | 0.016 | 0.016 | 0.016 | 0.016 | 0.016 | 0.016 | 0.016 | 0.016 | |
| 6-Benzylaminopurine | 0 | 0 | 0.011 | 0.011 | 0.011 | 0.011 | 0.011 | 0.011 | |
| Triacontanol | 0.004 | 0.004 | 0.004 | 0.004 | 0.004 | 0.004 | 0.004 | 0.004 | |
| Forchlorfenuron | 0 | 0 | 0.0025 | 0.0025 | 0.0025 | 0.0025 | 0.0025 | 0.0025 | |
| Units in #spores/100 L | | | | | | | | | |
| Bacillus laterosporous | 5 sup 9 | 5 sup 9 | 5 sup 9 | 5 sup 9 | 5 sup 9 | 5 sup 9 | 5 sup 9 | 5 sup 9 | |
| B. licheniformis | 8 sup 9 | 8 sup 9 | 8 sup 9 | 8 sup 9 | 8 sup 9 | 8 sup 9 | 8 sup 9 | 8 sup 9 | |
| B. Subtilus | 7 sup 9 | 7 sup 9 | 7 sup 9 | 7 sup 9 | 7 sup 9 | 7 sup 9 | 10 sup 10 | 7 sup 9 | |
| B. pumilus | 6 sup 9 | 6 sup 9 | 6 sup 9 | 6 sup 9 | 6 sup 9 | 6 sup 9 | 6 sup 9 | 6 sup 9 | |
| B. megaterium | 5 sup 9 | 5 sup 9 | 5 sup 9 | 5 sup 9 | 5 sup 9 | 5 sup 9 | 5 sup 9 | 5 sup 9 | |
| B. polymixa | 10 sup 9 | 10 sup 9 | 10 sup 9 | 10 sup 9 | 10 sup 9 | 10 sup 9 | 10 sup 9 | 10 sup 9 | |
| B. chinosporus | 5 sup 9 | 5 sup 9 | 5 sup 9 | 5 sup 9 | 5 sup 9 | 5 sup 9 | 5 sup 9 | 5 sup 9 | |
| Azospirillum lipoferum | 5 sup 9 | 5 sup 9 | 5 sup 9 | 5 sup 9 | 5 sup 9 | 5 sup 9 | 5 sup 9 | 5 sup 9 | |
| Azospirillum brasilense | 8 sup 9 | 8 sup 9 | 8 sup 9 | 8 sup 9 | 8 sup 9 | 8 sup 9 | 8 sup 9 | 8 sup 9 | |
| T. Harzianum | 8 sup 9 | | | 8 sup 9 | | | | | |
| T. polysporum | 7 sup 9 | | | 7 sup 9 | | | | | |
| T. viride | 7 sup 9 | | | 7 sup 9 | | | | | |
| T. koningii | 7 sup 9 | | | 7 sup 9 | | | | | |
| Glomus mosseae | 4 sup 9 | | | 4 sup 9 | | | | | |
| Glomus intraradices | 4 sup 9 | | | 4 sup 9 | | | | | |
| Glomus clarum | 4 sup 9 | | | 4 sup 9 | | | | | |
| Glomus momosporus | 4 sup 9 | | | 4 sup 9 | | | | | |
| Glomus deserticola | 5 sup 9 | | | 5 sup 9 | | | | | |
| Glomus brasilianum | 5 sup 9 | | | 5 sup 9 | | | | | |
| Glomas aggregatum | 5 sup 9 | | | 5 sup 9 | | | | | |
| Gigaspora margarita | 5 sup 9 | | | 5 sup 9 | | | | | |
| Pt (pisolithus) | 4 sup 9 | | | 4 sup 9 | | | | | |
| Rhizopogaon amiopogon | 3 sup 9 | | | 3 sup 9 | | | | | |
| Rhizopogon villosuli | 3 sup 9 | | | 3 sup 9 | | | | | |
| Rhizopogon fulvigelba | 9 sup 9 | | | 9 sup 9 | | | | | |
| Rhizopogon luteolus | 9 sup 9 | | | 9 sup 9 | | | | | |
| Laccaria laccata | 7 sup 9 | | | 7 sup 9 | | | | | |
| Laccaria bicolor | 7 sup 9 | | | 7 sup 9 | | | | | |
| Scleroderma cepa | 8 sup 9 | | | 8 sup 9 | | | | | |
| Scleroderma citrinum | 8 sup 9 | | | 8 sup 9 | | | | | |

TABLE 2
Beneficial Fungi
Tricoderma - T. harzianum, T. polysporum, T. viride, T. koningit

| EndoMycorrhiza | EctoMicorrhiza |
|---|---|
| Glomus mosseae | Pt (Pisolithus) |
| Glomus intraradices | Rhizopogon amylopogon |
| Glomus clarum | Rhizopogon villosuli |
| Glomus monosporus | Rhizopogon fulvigelba |
| Glomus deserticola | Rhizopogon luteolus |
| Glomus brasilianum | Laccaria laccata |
| Glomus aggregatum | Laccaria bicolor |
| Gigaspora margarita | Scleroderma cepa |
| | Scleroderma citrinum |

TABLE 3
Beneficial Bacteria

Bacteria - bacillus laterosporus, B. licheniformis,
B. Subtilus, B. pumilus, B. megaterium, B. polymixa,
B. chinosporus, Azospirillum lipoferum, Azospirillum brasilense

TABLE 4
Enzymes

Cellulases Endohydrolysis of 1,4-beta-D-
glucosidic linkages in cellulose, lichenin and
cereal beta-D-glucans. Will also hydrolyze
1,4-linkages in beta-D-glucans also
containing 1,3-linkages. Also know as:
Endoglucranase, Endo-I,4-beta-glucanase,
Carboxyinethyl cellulase. Endo-I,⁴-beta-
D-glucanase, Beta-I,4-glucanase, Beta-
1,4-endoglucan hydrolase, Celludextrinase,
Avicelase.
Polygalacturonases
Random hydrolysis of I.4-alpha-D-
galactosiduronic linkages in pectate and other
galacturonans. Also known as pectinase and
pectin depolymerase. Exo-hydrolytic
cleavage of galctosiduropie linkages is
galacturan 1,4-alpha-galacturonidase. Also
known as: Exopolygalacturonase,
Poly(gatacturonate)hydrolase.
Endo-1,4-beta-xylanese
Endohydrolysis oft,4-beta-D-xylosidic linkages
in cylans. Also know as: Xylanase
and I,4-beta-D-xylan xylanohydrolase.
Proteases enzymes hydrolyases acting
on peptide bonds.
Esterases enzymes hydrolyzing the ester
bonds of a wide range of chemicals.
Lipases enzymes hydrolyzing tri-, di- and
mono-acylglycerides.
Glycosylases enzymes with endo- and exo-
hydrolyzing activity against
oligosaccharides. Class included cellulose,
polyglacturonasc, xylanase, etc.
Nitrate reductase- Reduces nitrite to nitrate.
Also know as: Assimilatory nitrate
reductase, NADII-nitrate reductase, NADH-
dependent nitrate reductase,
Assimilatonj NADH: nitrate reductase,
Nitrate reductase (NADF(2)),
NADH: nitrate oxidoreductase.

TABLE 5
Amino Acids

L-ALANINE
L-ARGININE
L-ASPARGINE
L-ASPARTIC ACID
L-CYSTINE
L-CYSTEINE
L-GLUTAMINE
L-GLUTAMIC ACID
L-GLYCINE
L-HISTIDINE
L-ISOLEUCINE
L-LEUCINE
L-LYSINE
L-METHIONINE
L-PHENYLALANINE
L-PROLINE
L-SERINE
L-THREONINE
L-TRYPTOPHAN
L-TYROSINE
L˜VALINE

TABLE 6
Mono and Ortho Silicic
Mineral Analysis

| | |
|---|---|
| Alumina (Al₂O3) | Phosohorous Pentoxide (P₅O) |
| Barium Oxide (BaO) | Potassium Oxide (K₂O) |
| Calcium Oxide (CaO) | Silica Oxide (SiO2) |
| Carbon (C) (320) | Sodium Oxide (NaO₂) |
| Ferric Oxide (Fe₂O₃) (50,000) | Sulfur Trioxide (SO₃) |
| Hydrogen (H) | Strontium Oxide (Sit) |
| Magnesium Oxide (MgO) | Titania (TiO₂) |
| Manganese Oxide (Mn₂O₃) | Fluorine (Fl) |
| Chlorine (Cl) | |
| Element Analysys: | |
| Antimony (SB) | Gold (Au) |
| Arsenic (As) | Hafnium (Hf) |
| Beryllium (Be) | Holmium (Ho) |
| Bismuth (Bi) | Indium (In) |
| Boron (B) | Iodine (I) |
| Bromine (Br) | Iridium (Ir) |
| Cadmium (Cd) | Lathanum (La) |
| Cerium (Ce) | Lead (Pb) |
| Cesium (Cs) | Lithium (Li) |
| Chromium (Cr) | Lutetium (Lu) |
| Cobalt (Co) | Mercury (Hg) |
| Copper (Cu) | Molybdenum (Mo) |
| Dysprosium (Dy) | Neodymium (Md) |
| Eribium (Er) | Nickel (Ni) |
| Gadolinium (Gd) | Niobium (Nb) |
| Gallium (Ga) | Oxygen (O) |
| Germanium (Ge) | Thallium (Tm) |
| Praseodymium (Pr) | Thorium (Th) |
| Rubidium (Rb) | Thulium (Tm) |
| Ruthenium (Ru) | Tin (Fn) |
| Rhenium (Re) | Tungsten (W) |
| Tellurium (Te) | Uranium (U) |
| Samarium (Sm) | Vanadium (V) |
| Scandium (Sc) | Ytterbium (Yb) |
| Selenium (Se) | Yttrium (Y) |
| Silver (Ag) | Zinc (Zn) |
| Strontium (Sr) | Zirconium (Zr) |
| Sulfur (S) | |
| Tantalum (Ta) | |
| Terbium (Tb) | |

TABLE 7
ALFALFA

Phytochemicals Include: 3′-Methoxycoumestrol,
3-Methylbutanol, —O-Methylcoumestrol 4-Arnino-
Butyric-Acid, 11,12-Dimethoxy-7-Hydroxycoumestin,
Acetone, Adenine, Adenosine, Alfalfone, Alpha-
Spinasterol, Alpha-Tocopherol, Amylase, Arabinose,
Beta-sitosterol, Betaine, Biochanin-A, Butanone,
Calcium, Campesterol, Chlorophyllide-A, Choline,
Coagulase, Coumestrol, Cryptoxanthin, Cycloartenol,
Cytidine, Daidzen, Daphnoretin, Erepsin, Folacin,
Formononetin, Genistein, Guanine, Guanosine,
Hederagenin, Hentriacontane, Hydrogen-cyanide,
Hypoxanthine, Inosine, Inositol, Invertase,
Isocytosine, LHomostachydrine L-Stachydrine,
Limonene, Lucemol, Lutein, Magnesium, Malic-acid,
Malonic-acid, Manganese, Medicagenicacid, Medicagol,
Molybdenum, Myristone, Neoxanthin, Niacin,
Octacosanol, Oxalic, Pectin, Pectinase, Pentanal,
Peroxidase, Phaeophorbide-A, Phosphorus, Potassium,
Propanal, Protein, Pyridoxine, Quinic-acid,
Riboflavin, Ribose, Saponin, Sativol, Selenium,
Shikimic-acid, Silicon, Soyasapogenols, Stachydrine,
Stigmasterol, Succinic-acid, Tannin, Thiamin,
Triacontanol, Tricin, Trifoliol, Trigonelline,
Trimethylamine, Tryptophan, Violaxanthin, Vit-E,
Vit-K, Xanthophylls, Xylose, Zeaxanthin

TABLE 8
Compounds Of Ascophyllum Nodosum

Abscisic Acid (ABA)
Adenine
Indole acetic Acid (IAA)
Selenium (Se)
Sodium (Na)
Strontium (Sr)
Sulfur (S)
Tin (Sn)
Titanium (Ti)
Vanadium (V)
Zinc (Zn)
MINERALS:
Aluminum (Al)
Barium (Ba)
Beryllium (Be)
Boron (B)
Cadmium (Cd)
Calcium (Ca)
Chloride (Cl)
Chromium (Cr)
Cobalt (Co)
Copper (Cu)
Iron (Fe)
Lead (Pb)
Magnesium (Mg)
Manganese (Mn)
Mercury (Hg)
Molybdenum (Mo)
Nickel (Ni)
Nitrogen (N)
Phosphorus (I′)
Potassium (K)
AMINO ACID CONTENT:
Alanine
Arginine
Aspartic Acid
Cystine
Glutamic Acid
Glycine
Histidine
Isoleucine
Leucine
Lysine
Methionine
Phenylalanine
Proline
Serine
Threonine
Tryosine
Tryptophan
Vatine
VITAMINS:
Biotin
Carotene
Folic Acid
Riboflavin
Thiamin
Tocopherols
Vitamin C
Vitamin B12
Vitamin K
Other componds
Alginic Acid
Mannitol
Larninarin

TABLE 9
Master Container Configurations

Example 1:
8 Week Program Heavy Feeder
1 week vegetative cycle/7 week flowering and fruiting cycle -
100 L reservoir
1 week vegetative cycle- 1^{st} week 1000-1400 ppm
7 weeks flowering and fruiting cycle,
1^{st} week, 1000-1500 ppm; 2^{nd} week, 1200-1700 ppm;
3^{rd} week, 1400-1900 ppm; 4^{th} week, 1600-2100 ppm;
5^{th} week, 1400-1900 ppm; 6^{th} week, 1200-1700 ppm.
Example 2:
10 Week Program Medium-Feeder
2 week vegetative cycle/8 week flowering and fruiting cycle -
100 L reservoir
2 week vegetative cycle - 1^{st} week 800-1200 ppm
2^{nd} week 800-1200 ppm
8 weeks flowering and fruiting cycle,
1^{st} week, 900-1200 ppm; 2^{nd} week, 950-1250 ppm;
3^{rd} week, 1000-1300 ppm; 4^{th} week, 1050-1350 ppm;
5^{th} week, 1100-1500 ppm; 6^{th} week, 1050-1350 ppm;
7^{th} week, 1000-1300 ppm; 8^{th} week, 200-400 ppm.
Example 3:
13 Week Program Very Light Feeder
3 week vegetative cycle/10 week flowering and fruiting cycle -
100 L reservoir
3 week vegetative cycle- 1^{st} week 600-1000,
2^{nd} week 600-1000, 3^{rd} week 600-1000 ppm
10 week Flowering and fruiting -
1^{st} week, 800-960 ppm; 2^{nd} week, 850-1000 ppm;
3^{rd} week, 900-1050 ppm; 4^{th} week, 950-1100 ppm;
5^{th} week 1000-1150 ppm; 6^{th} week, 1050-1200 ppm;
7^{th} week, 1000-1150 ppm; 8^{th} week, 950-1100 ppm;
9^{th} week, 900-1050 ppm; 10^{th} week 200-400 ppm.

The embodiment of the invention in which an exclusive property or privilege is claimed are defined as follows:

1. A plant nutrient kit comprising:
(a) a master container;
(b) a plurality of formulation containers;
(c) a plurality of nutrient containers comprising nutrients; and
(d) instructions,
wherein:
(a) each master container comprises the plurality of formulation containers which together comprise a nutrient lode according to a schedule;
(b) each formulation container comprises a plurality of nutrient containers which together comprise a formulation according to a formula of the schedule; and
(c) each nutrient container comprises contents selected from the group comprising an individual nutrient and a permitted combination of nutrients, wherein the quantity of contents is determined according to the formula.

2. The plant nutrient kit of claim 1 further comprising a plurality of dividers that divide the space within the master container into compartments.

3. The plant nutrient kit of claim 1 wherein:
(a) the master container is selected from the group comprising a carton, a box, a bag, a bottle, a cylinder, and an envelope;
(b) the formulation container is selected from the group comprising a carton, a box, a bag, a bottle, a cylinder, and an envelope; and
(c) the nutrient container is selected from the group comprising a squeeze tube, a carton, a jar, a bag, a bottle, a cyclinder, and envelope.

4. The plant nutrient kit of claim 1 wherein the formula is selected from the group comprising a daily formula, a multiple-day formula, a weekly formula, a biweekly formula, and a monthly formula.

5. A formulation container comprising a plurality of nutrient containers which together comprise a formation according to a formula of a schedule.

6. A method of providing nutrients to plants, comprising the steps of:
(a) providing a master container comprising instructions and a plurality of formulation containers, each of which formulation containers further comprises a formulation according to a formula of schedule;
(b) removing from the master container a formulation container according to the schedule;
(c) removing nutrient components of the formulation from the formulation container; (d) dissolving the nutrient components of the formulation in a volume of water according to the instructions to make a nutrient solutions;
(e) applying the nutrient solution to a hydroponic system; and
(f) repeating steps (b) through (e) according to the schedule as set out in the instructions.

7. Use of the plant nutrient kit of claim 1 in a hyroponic growing system selected from the group comprising aeroponics, drip irrigation, flood and drain, wick, and NFT systems.

8. Use of the plant nutrient kit of claim 1 in a growing medium selected from the group comprising rock-wool, sphagnum moss, leca, coir, lava rock, and conventional soil mixes.

9. A hydroponic plant nutrient system comprising a master ccontainer which further comprises a plurality of formulation containers wherein each formulation container further comprises a plurality of nutrients which together comprise a formulation, and wherein the nutrients are precalibrated for a specific nutrient strength.

10. The formulation container of claim 9.

11. A hydroponic plant nutrient system comprising a master container which further comprises a plurality of formulation containers wherein each formulation container further comprises a plurality of nutrient containers which together comprise a formulation according to a schedule, and wherein the nutrients are premeasured for a specific reservoir size.

12. The formulation container of claim 11.

13. A plant nutrient system comprising a master container which further comprises a plurality of formulation containers wherein each formulation container further comprises a plurality of nutrient containers which together comprise a formulation according to a schedule, configured in growing profiles for the growth cycle selected from the group comprising a progressively weaker profile, a multiple peak profile, a progressively weaker then sustained then progressively weaker profile, and a progressively weaker then sustained then progressively stronger profile.

14. The plant nutrient kit of claim 1 wherein the formulation is self-adjusting in a range of about pH 5.5 to 6.5.

15. A plant nutrient system comprising a master container which further comprises a plurality of formulation containers wherein each formulation container further comprises a plurality of nutrient containers which together comprise a formulation according to a schedule, and wherein said nutrients comprise macronutrients, micronutrients, vitamins, amino acids, yeast extracts, enzymes, hormones, beneficial bacteria, beneficial fungi, organic ingredients and organic extracts.

16. A plant nutrient system comprising a master container which further comprises a plurality of formulation containers wherein each formulation container further comprises a plurality of nutrient containers which together comprise a formulation according to a schedule, and wherein said nutrients comprise macronutrients, micronutrients, vitamins, amino acids, yeast extracts, enzymes, hormones, beneficial bacteria, beneficial fungi, organic ingredients and organic extracts.

17. A plant nutrient system comprising a master container which further comprises a plurality of formulation containers wherein each formulation container further comprises a plurality of nutrient containers which together comprise a formulation according to a schedule is for a growth cycle comprising a flowering and fruiting phase.

18. A plant nutrient system comprising a master container which further comprises a plurality of formulation containers wherein each formulation container further comprises a plurality of nutrient containers which together comprise a formulation according to a schedule wherein said schedule is for growth cycle comprising a combination of a vegetative phase and a flowering and fruiting phase.

19. A plant nutrient system comprising a master container which further comprises a plurality of formulation containers wherein each formulation container further comprises a plurality of nutrient containers which together comprise a formulation according to a schedule wherein said formulation is a chronologically sequential formulation according to a schedule.

20. The formulation container of claim 11, 15, 16, 17, 18, & 19.

21. A plant nutrient system comprising a master container which further comprises a plurality of formulation containers wherein each formulation container further comprises a plurality of nutrient containers which together comprise a formulation according to a schedule wherein said nutreints are in the ratios defined in the schedule of Table 1.
